(19) United States
(12) Patent Application Publication
(10) Pub. No.: US 2025/0218708 A1
(43) Pub. Date: Jul. 3, 2025

(54) SNAP SWITCH

(71) Applicant: C&K COMPONENTS S.A.S., Dole (FR)

(72) Inventor: Rémi Martin, ROUVRES-EN-PLAINE (FR)

(73) Assignee: C&K COMPONENTS S.A.S., Dole (FR)

(21) Appl. No.: 19/004,651

(22) Filed: Dec. 30, 2024

Related U.S. Application Data
(60) Provisional application No. 63/615,339, filed on Dec. 28, 2023.

(51) Int. Cl. H01H 13/28; H01H 5/06; H01H 13/04

(52) U.S. Cl. CPC H01H 13/28; H01H 5/06; H01H 13/04

(57) ABSTRACT

Movable electrical contacts on a movable part of a snap switch can be in a first position relative to fixed electrical contacts on a housing when vertical forces applied by a first spring and a second spring and a reaction force applied by a third spring cause the movable part to be in an upper position within the housing. The movable electrical contacts can be in a second position relative to the fixed electrical contacts when the vertical forces applied by the first spring and the second spring and the reaction force applied by the third spring cause the movable part to be in a lower position within the housing. The first spring and the second spring can apply forces on the movable part in opposite directions, and the movable part can vertically move between the upper stop position and the lower stop position.

### CROSS-REFERENCE TO RELATED APPLICATIONS

This application claims the benefit of priority to U.S. Provisional Patent Application No. 63/615,339, filed Dec. 28, 2023, entitled “Snap Switch,” which is incorporated herein by reference in its entirety.

### FIELD

The present disclosure generally relates to electromechanical switches. More particularly, the present disclosure relates to snap switches.

### BACKGROUND

Electronic parking brakes are digitally actuated via a button, and when actuated, an electronic control unit signals an actuator to set a parking brake, thereby eliminating any physical effort by a driver. Switches in known electronic parking brakes are based on rotation of a movable part that carries or activates movable contacts when the actuator reaches a snap position. For example, in switches in some known electronic parking brakes, a traction spring is extended between the actuator and the movable part, and as the actuator is pushed, a line defined by hook points of the traction spring coincides with a rotation axis of the movable part, thereby causing the movable part to snap through or snap back.

Footprints of known switches in electronic parking brakes must be large enough to accommodate rotating parts therein. For example, known switches are on the order of 7.4 mm×15.4 mm or 8.4 mm×15.4 mm. However, smaller footprints are desirable and even necessary in certain applications.

In view of the above, there is a continuing, ongoing need for improved switches that can be used in electronic parking brakes.

### BRIEF SUMMARY

This Brief Summary is provided to introduce a selection of concepts in a simplified form that are further described below in the Detailed Description. This Brief Summary is not intended to identify key features or essential features of claimed subject matter or intended as an aid in determining scope of the claimed subject matter.

In some embodiments, a switch in accordance with the present disclosure can include a housing with a plurality of fixed electrical contacts, an actuator located within the housing, a movable part with at least one movable electrical contact and located within the housing, a first spring located between the actuator and the movable part and applying a first force on the movable part in a first direction, a second spring located between the actuator and the movable part and applying a second force on the movable part in a second direction, the second direction being opposite the first direction, and a third spring applying a reaction force on the movable part. The movable part can be on a first side of the third spring when the first force applied by the first spring on the movable part is lower than a sum of the second force applied by the second spring on the movable part and the reaction force applied by the third spring on the movable part, and the at least one movable electrical contact can be in a first position relative to the plurality of fixed electrical contacts when the movable part is on the first side of the third spring. An outside force applied to the actuator can increase the first force applied by the first spring on the movable part and decrease the second force applied by the second spring on the movable part until an equilibrium is reached therebetween and the movable part pushes the third spring and moves to a second side of the third spring. The movable part can be on the second side of the third spring when the second force applied by the second spring on the movable part is lower than a sum of the first force applied by the first spring on the movable part and the reaction force applied by the third spring on the movable part, and the at least one movable electrical contact can be in a second position relative to the plurality of fixed electrical contacts when the movable part is on the second side of the third spring. Removal of the outside force applied to the actuator can decrease the first force applied by the first spring on the movable part and increase the second force applied by the second spring on the movable part until the equilibrium is reached therebetween and the movable part pushes the third spring and moves to the first side of the third spring.

In some embodiments, a top cover of the housing can provide a stopping mechanism for the movable part and apply a third force on the movable part in the first direction when the movable part is on the first side of the third spring.

In some embodiments, a bottom of the housing can provide a stopping mechanism for the movable part when the movable part is on the second side of the third spring.

In some embodiments, potential energy in the first spring can be converted into kinetic energy to move the movable part from first side of the third spring to the second side of the third spring.

In some embodiments, potential energy in the second spring can be converted into kinetic energy to move the movable part from the second side of the third spring to the first side of the third spring.

In some embodiments, the first spring and the second spring can circumscribe at least part of the actuator.

In some embodiments, the movable part can circumscribe at least part of the first spring and at least part of the second spring.

In some embodiments, the switch can include a fourth spring located between the actuator and the housing, and the fourth spring can apply a return force to the actuator when the outside force applied to actuator is removed.

In some embodiments, a switch in accordance with the present disclosure can include a housing with a plurality of fixed electrical contacts, an actuator located within the housing, a movable part with at least one movable electrical contact and located within the housing, a first spring located between the actuator and the movable part and applying a first force on the movable part in a first direction, a second spring located between the actuator and the movable part and applying a second force on the movable part in a second direction, the second direction being opposite the first direction, and a third spring applying a reaction force on the movable part. The at least one movable electrical contact can be in a first position relative to the plurality of fixed electrical contacts when the first force applied by the first spring on the movable part, the second force applied by the second spring on the movable part, and the reaction force applied by the third spring on the movable part cause the movable part to be on a first side of the third spring. The at least one movable electrical contact can be in a second position relative to the plurality of fixed electrical contacts when the first force applied by the first spring on the movable part, the second force applied by the second spring on the movable part, and the reaction force applied by the third spring on the movable part cause the movable part to be on a second side of the third spring. The movable part can move between the first side of the third spring and the second side of the third spring.

In some embodiments, an outside force applied to or removed from the actuator can change the first force applied by the first spring on the movable part and the second force applied by the second spring on the movable part.

In some embodiments, the reaction force can be applied to the movable part in a third direction, and the third direction can be different than the first direction and the second direction.

In some embodiments, the third direction can include a horizontal direction.

In some embodiments, the third spring can undergo snap-through buckling to facilitate the movable part moving between the first side of the third spring and the second side of the third spring.

In some embodiments, in the first position, the at least one movable electrical contact can be electrically connected to a first subset of the plurality of fixed electrical contacts, and in the second position, the at least one movable electrical contact can be electrically connected to a second subset of the plurality of fixed electrical contacts. The first subset can be separate from the second subset.

In some embodiments, a method in accordance with the present disclosure can include applying a first force from a first spring, a second force from a second spring, and a reaction force by a third spring to a movable part to dispose the movable part on a first side of the third spring within a housing, electrically connecting at least one movable electrical contact on the movable part with a first subset of a plurality of fixed electrical contacts on the housing when the movable part is on the first side of the third spring, increasing the first force from the first spring and decreasing the second force from the second spring applied to the movable part until the movable part snaps through the third spring to move from the first side of the third spring to a second side of the third spring within the housing, and electrically connecting the at least one movable electrical contact with a second subset of the plurality of fixed electrical contacts when the movable part is on the second side of the third spring.

In some embodiments, the method can include decreasing the first force from the first spring and increasing the second force from the second spring applied to the movable part until the movable part snaps through the third spring to move from the second side of the third spring to the first side of the third spring.

In some embodiments, the method can include increasing and decreasing the first force from the first spring and the second force from the second spring via an actuator located within the housing.

In some embodiments, the actuator can be responsive to an outside force.

In some embodiments, the method can include applying the first force from the first spring to the movable part in a first direction and applying the second force from the second spring to the movable part in a second direction. The first direction can be opposite the second direction.

In some embodiments, the method can include applying the reaction force from the third spring to the movable part in a third direction, The third direction can be different than the first direction and the second direction.

Other technical features may be readily apparent to one skilled in the art from the following figures, descriptions, and claims.

### BRIEF DESCRIPTION OF THE SEVERAL VIEWS OF THE DRAWINGS

FIG. 1A is an exploded view illustrating a snap switch in accordance with disclosed embodiments.

FIG. 1B is a cross-sectional view illustrating a snap switch in accordance with disclosed embodiments.

FIG. 2A is a schematic diagram illustrating a snap switch in accordance with disclosed embodiments.

FIG. 2B is a block diagram illustrating electrical contacts of a snap switch in accordance with disclosed embodiments.

FIG. 2C is a circuit diagram illustrating electrical contacts of a snap switch in accordance with disclosed embodiments.

FIG. 3 is a perspective view illustrating fixed electrical contacts and a movable part with movable electrical contacts of a snap switch in accordance with disclosed embodiments.

FIG. 4 is a perspective view illustrating electrical contacts of a snap switch in accordance with disclosed embodiments.

FIG. 5A is a schematic diagram illustrating a snap switch in accordance with disclosed embodiments.

FIG. 5B is a block diagram illustrating electrical contacts of a snap switch in accordance with disclosed embodiments.

FIG. 5C is a circuit diagram illustrating electrical contacts of a snap switch in accordance with disclosed embodiments.

FIG. 6A is a schematic diagram illustrating a snap switch in accordance with disclosed embodiments.

FIG. 6B is a block diagram illustrating electrical contacts of a snap switch in accordance with disclosed embodiments.

FIG. 6C is a circuit diagram illustrating electrical contacts of a snap switch in accordance with disclosed embodiments.

FIG. 7 is a perspective view illustrating fixed electrical contacts and a movable part with movable electrical contacts of a snap switch in accordance with disclosed embodiments.

FIG. 8 is a perspective view illustrating electrical contacts of a snap switch in accordance with disclosed embodiments.

FIG. 9A is a schematic diagram illustrating a snap switch in accordance with disclosed embodiments.

FIG. 9B is a block diagram illustrating electrical contacts of a snap switch in accordance with disclosed embodiments.

FIG. 9C is a circuit diagram illustrating electrical contacts of a snap switch in accordance with disclosed embodiments.

FIG. 10A is a schematic diagram illustrating a snap switch in accordance with disclosed embodiments.

FIG. 10B is a block diagram illustrating electrical contacts of a snap switch in accordance with disclosed embodiments.

FIG. 10C is a circuit diagram illustrating electrical contacts of a snap switch in accordance with disclosed embodiments.

FIG. 11A is a schematic diagram illustrating a snap switch in accordance with disclosed embodiments.

FIG. 11B is a block diagram illustrating electrical contacts of a snap switch in accordance with disclosed embodiments.

FIG. 11C is a circuit diagram illustrating electrical contacts of a snap switch in accordance with disclosed embodiments.

FIG. 12 is a graph illustrating a force-displacement curve in accordance with disclosed embodiments.

FIG. 13A is a graph illustrating snap-through in accordance with disclosed embodiments.

FIG. 13B is a graph illustrating snap-back in accordance with disclosed embodiments.

FIG. 14 is a flow chart of a method in accordance with disclosed embodiments.

### DETAILED DESCRIPTION

Exemplary embodiments of a snap switch in accordance with the present disclosure will now be described more fully hereinafter with reference made to the accompanying drawings. The snap switch may, however, be embodied in many different forms and should not be construed as being limited to the embodiments set forth herein. Rather, these embodiments are provided so that this disclosure will convey certain exemplary aspects of the snap switch to those skilled in the art.

In accordance with disclosed embodiments, a snap switch can include a DPDT (Double-Pole Double Through) contact arrangement such that electrical contacts are electrically independent, but mechanically linked. That is, positions of movable parts within the snap switch can define an electrical function of the snap switch.

In some embodiments, the snap switch can include a housing, an actuator, a movable part, a first spring, a second spring, and a third spring. The housing can include a plurality of fixed electrical contacts, and the actuator can be located within the housing. The movable part can include a plurality of movable electrical contacts and also be located within the housing. The first spring can be preloaded between the actuator and the movable part and apply a first vertical force on the movable part in a first vertical direction, and the second spring can be preloaded between the actuator and the movable part and apply a second vertical force on the movable part in a second vertical direction. Finally, the third spring can apply a reaction force on the movable part. In some embodiments, the first spring and the second spring can circumscribe at least part of the actuator, and in some embodiments, the movable part can circumscribe at least part of the first spring and at least part of the second spring. Alternatively, in some embodiments, the actuator can be flat with the first spring and the second spring pushing on sides thereof and/or the movable part can be flat with the first spring and the second spring pushing on sides thereof. In some embodiments, the third spring can include a lever.

It is to be understood that the second vertical direction can be opposite the first vertical direction. As such, the movable part can be in an upper stop position when the first vertical force applied by the first spring on the movable part is lower than a sum of the second vertical force applied by the second spring on the movable part and the reaction force applied by the third spring on the movable part. When the movable part is in the upper stop position, each of the plurality of movable electrical contacts can be in a first position relative to the plurality of fixed electrical contacts.

In some embodiments, each of the plurality of movable electrical contacts can be in the first position relative to the plurality of fixed electrical contacts when the first vertical force applied by the first spring on the movable part, the second vertical force applied by the second spring on the movable part, and the reaction force applied by the third spring on the movable part cause the movable part to be in the upper stop position within the housing. In some embodiments of the first position, each of the plurality of movable electrical contacts can be electrically connected to a first subset of the plurality of fixed electrical contacts.

An outside force, such as a hand or a finger pushing on the actuator, can be applied to the actuator to change the first vertical force applied by the first spring on the movable part and the second vertical force applied by the second spring on the movable part. In particular, the outside force can be applied to the actuator to increase the first vertical force applied by the first spring on the movable part and decrease the second vertical force applied by the second spring on the movable part until an equilibrium is reached therebetween. When the equilibrium is reached, the movable part can push (or snap) the third spring and vertically move to a lower stop position. In this regard, potential energy in the first spring can be converted into kinetic energy to move the movable part from the upper stop position to the lower stop position. In some embodiments, the third spring can undergo snap-through buckling to facilitate the movable part moving between the upper stop position and the lower stop position.

In some embodiments, a top cover of the housing can provide a stopping mechanism for the movable part (and the actuator) in the upper stop position and apply a third vertical force on the movable part in the first vertical direction when the movable part is in the upper stop position. Additionally or alternatively, in some embodiments, a bottom of the housing can provide a stopping mechanism for the movable part (and the actuator) in the lower stop position.

The movable part can be in the lower stop position when the second vertical force applied by the second spring on the movable part is lower than a sum of the first vertical force applied by the first spring on the movable part and the reaction force applied by the third spring on the movable part. When the movable part is in the lower stop position, each of the plurality of movable electrical contacts can be in a second position relative to the plurality of fixed electrical contacts.

In some embodiments, each of the plurality of movable electrical contacts can be in the second position relative to the plurality of fixed electrical contacts when the first vertical force applied by the first spring on the movable part, the second vertical force applied by the second spring on the movable part, and the reaction force applied by the third spring on the movable part cause the movable part to be in the lower stop position within the housing. In some embodiments of the second position, each of the plurality of movable electrical contacts can be electrically connected to a second subset of the plurality of fixed electrical contacts such that the first subset of the plurality of fixed electrical contacts can be separate from the second subset of the plurality of fixed electrical contacts.

The outside force applied to the actuator can be removed to change the first vertical force applied by the first spring on the movable part and the second vertical force applied by the second spring on the movable part. In particular, the outside force applied to the actuator can be removed to decrease the first vertical force applied by the first spring on the movable part and increase the second vertical force applied by the second spring on the movable part until the equilibrium is reached therebetween. When the equilibrium is reached, the movable part can push (or snap) the third spring and vertically move to the upper stop position. In this regard, potential energy in the second spring can be converted into kinetic energy to move the movable part from the lower stop position to the upper stop position. In some embodiments, the third spring can undergo snap-through buckling to facilitate the movable part moving between the lower stop position and the upper stop position.

In some embodiments, the snap switch can include a fourth spring preloaded between the actuator and the housing, and in these embodiments, the fourth spring can apply a return force to the actuator when the outside force applied to actuator is removed.

In some embodiments, the reaction force can be applied to the movable part in a third direction, and the third direction can be different than the first vertical direction and the second vertical direction. In some embodiments, the third direction can include a horizontal direction.

Advantageously, the snap switch disclosed and described herein can have a footprint smaller than footprints of snap switches known the in the art because rotating parts are eliminated in lieu of movable parts translating vertically. For example, in some embodiments, the footprint of the snap switch disclosed and described herein can be approximately 8.5 mm×8.5 mm.

In some embodiments, a method that can be executed by the snap switch can include applying the first vertical force from the first spring, the second vertical force from the second spring, and the reaction force by the third spring to the movable part to dispose the movable part in the upper stop position within the housing, electrically connecting the plurality of movable electrical contacts on the movable part with the first subset of the plurality of fixed electrical contacts on the housing when the movable part is in the upper stop position, increasing the first vertical force from the first spring and decreasing the second vertical force from the second spring applied to the movable part until the movable part snaps through the third spring to vertically move from the upper stop position to the lower stop position within the housing, and electrically connecting the plurality of movable electrical contacts with the second subset of the plurality of fixed electrical contacts when the movable part is in the lower stop position.

In particular, in some embodiments, the method can include applying the first vertical force from the first spring to the movable part in the first vertical direction and applying the second vertical force from the second spring to the movable part in the second vertical direction, and in some embodiments, the first vertical direction can be opposite the second vertical direction. Furthermore, in some embodiments, the method can include applying the reaction force from the third spring to the movable part in the third direction, and in some embodiments, the third direction can be different than the first vertical direction and the second vertical direction.

In some embodiments, the method can also include decreasing the first vertical force from the first spring and increasing the second vertical force from the second spring applied to the movable part until the movable part snaps through the third spring to vertically move from the lower stop position to the upper stop position.

In some embodiments, increasing and decreasing the first vertical force from the first spring and the second vertical force from the second spring can be executed via the actuator located within the housing, and in some embodiments, the actuator can be moved responsive to the outside force.

Advantageously, the snap switch disclosed and described herein can be customizable in terms of force and/or travel characteristics. In particular, parameters of the snap switch, such as, for example, a stiffness of one or more springs therein (and thus, the first vertical force and the second vertical force applied to the movable part) and a shape of the third spring (and thus, the reaction force applied to the movable part), can be increased or decreased as desired to customize force and/or travel characteristics of the snap switch. In any embodiment, the snap switch can require momentary and/or a low activation force while still achieving a short switching time (e.g., less than 15 ms) regardless of an activation speed of the snap switch.

Although some embodiments of the snap switch are described in connection with the upper stop position and the lower stop position for the movable part, it is to be understood that other embodiments of the snap switch disclosed and described herein are contemplated. In this regard, in some embodiments, movement of the movable part need not be limited by the upper stop position and the lower stop position. Instead, in some embodiments, the movable part can slide before and/or after snap-through and/or snap-back as long as a configuration of the plurality of movable electrical contacts relative to the plurality of fixed electrical contacts changes when the movable part moves from a first side of the third spring to a second side of the third spring.

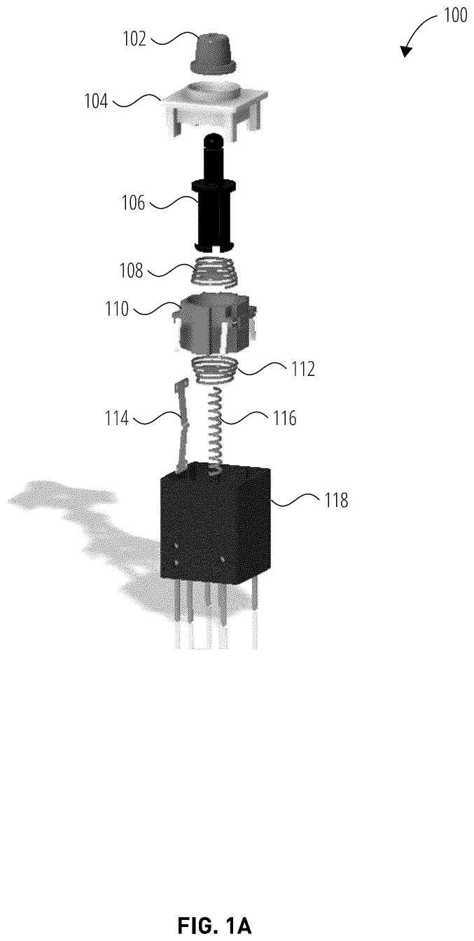

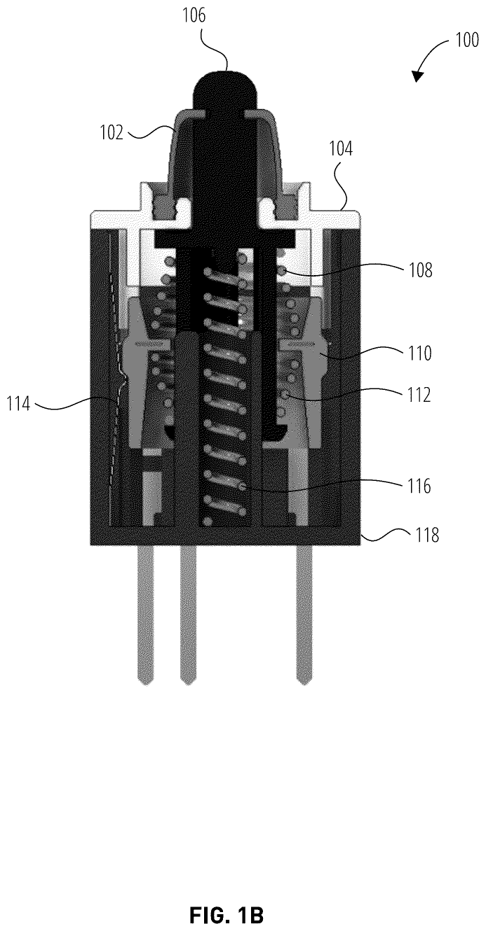

FIG. 1A is an exploded view illustrating a snap switch 100 in accordance with disclosed embodiments, and FIG. 1B is a cross-sectional view of the snap switch 100. As seen, the snap switch 100 can include a housing 118, an actuator 106, a top cover 104, a sealing boot 102, a movable part 110, a first spring 108, a second spring 112, a third spring 114, and a fourth spring 116. Although not specifically shown, it is to be understood that, in some embodiments, one or more free gaps can be located between various components of the snap switch 100, such as between the movable part 110 and the third spring 114.

In some embodiments, the housing 118 can include sub-assembled or over-molded fixed electrical contacts on a plastic portion of the housing 118. In some embodiments, the top cover 104 can be laser welded on the housing 118, and in some embodiments, the sealing boot 102 can be crimped on the top cover 104 and clipped in or on the actuator 106.

In some embodiments, the movable part 110 can include sub-assembled or over-molded movable electrical contacts on a plastic portion of the movable part 110. In some embodiments, the movable part 110 can include a ramp shape.

In some embodiments, one, some, or all of the first spring 108, the second spring 112, and the fourth spring 116 can include a compression spring and be helicoidal and/or conical in shape.

In some embodiments, the third spring 114 can include a deformable obstacle inside of the housing 118 that can retreat when a snap position is reached.

In some embodiments, at least the actuator 106 and the movable part 110 can be located within the housing 118, and in some embodiments, one, some, or all of the first spring 108, the second spring 112, and the third spring 114 can also be located within the housing 118. For example, the first spring 108 can be located between the actuator 106 and the movable part 110 and apply a first force on the movable part 110 in a first direction. The second spring 112 can be located between the actuator 106 and the movable part 110 and apply a second force on the movable part 110 in a second direction. In some embodiments, the first direction can be opposite the second direction. The third spring 114 can apply a reaction force on the movable part 110, and in some embodiments, the reaction force can be applied to the moveable part 110 in a third direction that is different from the first direction and the third direction. For example, in some embodiments, the first direction and the second direction can be vertical directions, and the third direction can be a horizontal direction.

In some embodiments, the first spring 108 and the second spring 112 can circumscribe at least part of the actuator 106. Additionally or alternatively, in some embodiments, the moveable part 110 can circumscribe at least part of the first spring 108 and at least part of the second spring 112.

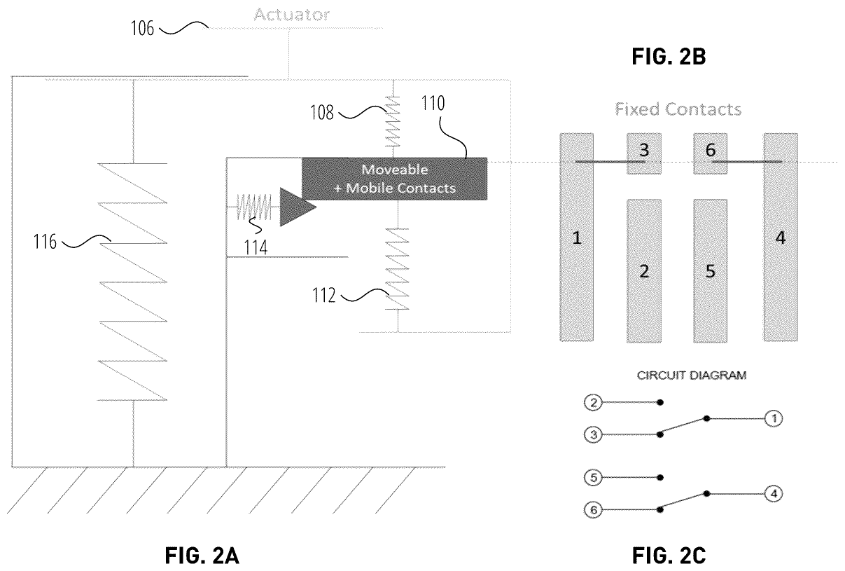

FIG. 2A, FIG. 2B, and FIG. 2C illustrate the snap switch 100 in a free position before the actuator 106 receives any outside force thereon. In some embodiments, the free position can be the only stable position of the snap switch 100. As seen, forces applied by the first spring 108, the second spring 112, and the third spring 114 can cause the movable part 110 to be in an upper stop position. In particular, at least one movable electrical contact on the moveable part 110 can be in a first position relative to the fixed electrical contacts on the housing 118 when the first force applied by the first spring 108 on the movable part 110, the second force applied by the second spring 112 on the movable part 110, and the reaction force applied by the third spring 114 on the movable part 110 cause the movable part 110 to be on a first side of the third spring 114. That is, the movable part 110 can be on the first side of the third spring 114 because the first force applied by the first spring 108 on the movable part 110 is lower than a sum of the second force applied by the second spring 112 and the reaction force applied by the third spring 114 on the movable part 110. As such, a first of the movable electrical contacts on the movable part 110 can connect fixed electrical contacts 1 and 3 on the housing 118, and a second of the movable electrical contacts on the movable part 110 can connect fixed electrical contacts 4 and 6 on the housing 118.

In some embodiments, the top cover 104 can provide a stopping mechanism for the moveable part 110 when in the upper stop position. For example, in these embodiments, the top cover 104 can apply a third force on the moveable part 110 in the first direction when the moveable part 110 is on the first side of the third spring 114.

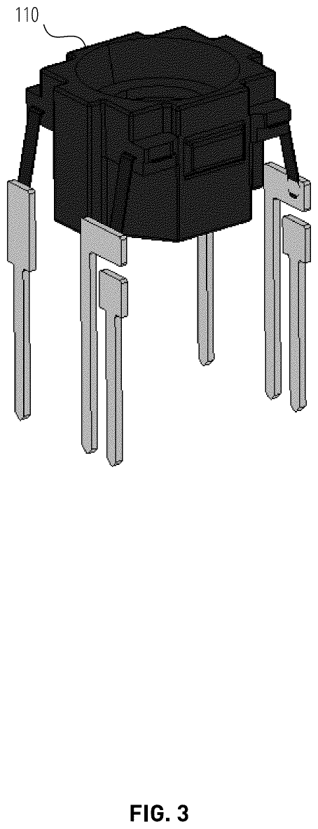

FIG. 3 and FIG. 4 illustrate the movable electrical contacts and the fixed electrical contacts when the snap switch 100 is in the free position. In the illustrated embodiments, the housing 118 includes 6 fixed electrical contacts, and the movable part 110 includes 2 movable electrical contacts. However, embodiments disclosed herein are not so limited and can include any number of fixed electrical contacts and movable electrical contacts as would be desired by one of ordinary skill in the art. As seen, the first of the movable electrical contacts on the movable part 110 and the second of the movable electrical contacts on the movable part 110 can be in the first position relative to the fixed electrical contacts when the snap switch 100 is in the free position, that is, the movable part 110 is in the upper stop position and/or on the first side of the third spring 114.

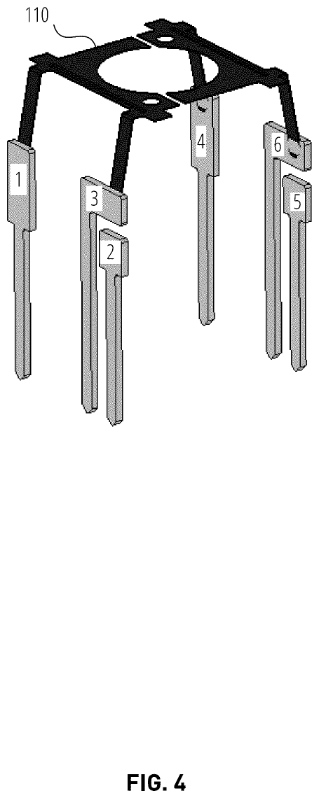

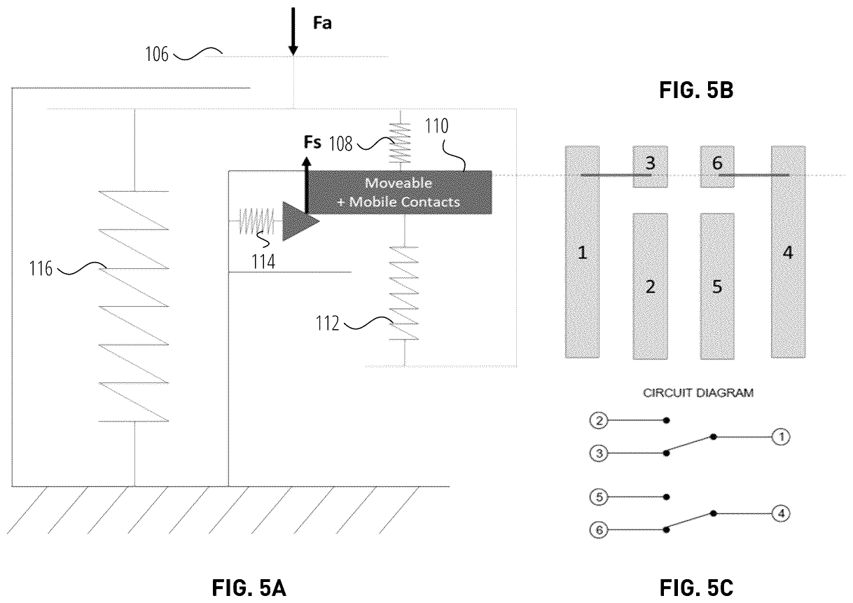

FIG. 5A, FIG. 5B, and FIG. 5C illustrate the snap switch 100 in an unstable position after the actuator 106 receives some outside force thereon, but not enough to move the third spring 114. As seen, an activation force Fa can be applied to the actuator 106, but the reaction force Fs applied by the third spring 114 can still cause the movable part 110 to be in the upper stop position. In particular, the movable part 110 can be on the first side of the third spring 114 because the first force applied by the first spring 108 on the movable part 110 is lower than the sum of the second force applied by the second spring 112 and the reaction force applied by the third spring 114 on the movable part 110. As such, the first of the movable electrical contacts on the movable part 110 can connect fixed electrical contacts 1 and 3 on the housing 118, and the second of the movable electrical contacts on the movable part 110 can connect fixed electrical contacts 4 and 6 on the housing 118.

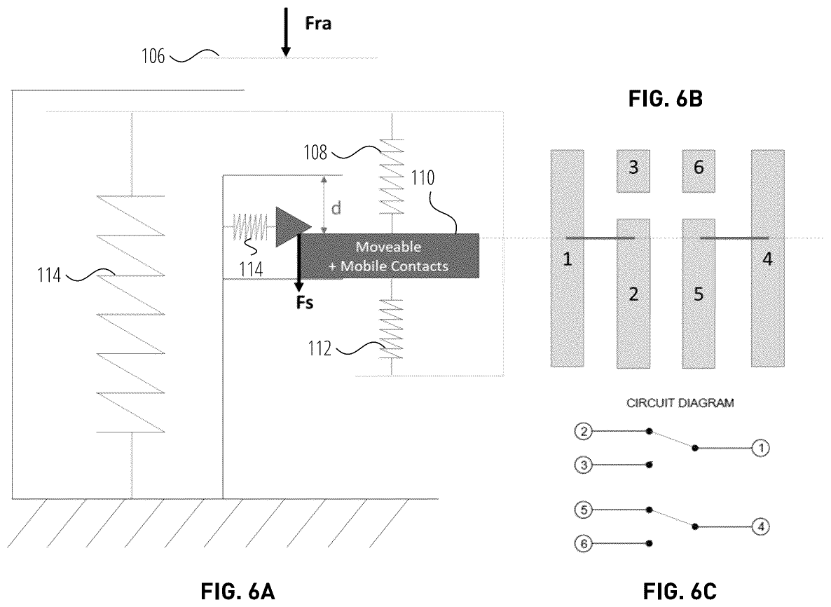

As will be described herein, an outside force applied to or removed from the actuator 106 can change the first force applied by the first spring 108 on the moveable part 110 and the second force applied by the second spring 112 on the moveable part 110. In this regard, FIG. 6A, FIG. 6B, and FIG. 6C illustrate the snap switch 100 after snap-through, that is, after displacing the third spring 114, and in an activated position. As seen, a force after snap-through Fra can be applied to the actuator 106 and be strong enough to cause the reaction force Fs to cause the movable part 110 to move to a lower stop position. That is, the outside force applied to the actuator 106 can increase the first force applied by the first spring 108 on the movable part 110 and decrease the second force applied by the second spring 112 on the movable part 110 until an equilibrium is reached therebetween and the movable part 110 pushes the third spring 114 and moves to a second side of the third spring 114. In some embodiments, the third spring 114 can undergo snap-through buckling to facilitate the moveable part 110 moving between the first side of the third spring 114 and the second side of the third spring 114. Furthermore, in some embodiments, potential energy in the first spring 108 can be converted into kinetic energy to move the moveable part 110 from the first side of the third spring 114 to the second side of the third spring 114. In particular, at least one movable electrical contact on the moveable part 110 can be in a second position relative to the fixed electrical contacts on the housing 118 when the first force applied by the first spring 108 on the movable part 110, the second force applied by the second spring 112 on the movable part 110, and the reaction force applied by the third spring 114 on the movable part 110 cause the movable part 110 to be on the second side of the third spring 114. That is, the movable part 110 can be on the second side of the third spring 114 because the second force applied by the second spring 112 on the movable part 110 is lower than a sum of the first force applied by the first spring 108 on the movable part 110 and the reaction force applied by the third spring 114 on the movable part 110. As such, the first of the movable electrical contacts on the movable part 110 can connect fixed electrical contacts 1 and 2 on the housing 118, and the second of the movable electrical contacts on the movable part 110 can connect fixed electrical contacts 4 and 5 on the housing 118.

As explained above, in the first position, the first of the movable electrical contacts on the movable part 110 can connect fixed electrical contacts 1 and 3 on the housing 118, and the second of the movable electrical contacts on the movable part 110 can connect fixed electrical contacts 4 and 6 on the housing 118. That is, in the first position, the moveable electrical contacts on the moveable part 110 can be electrically connected to a first subset of the fixed electrical contacts on the housing 118. Similarly, in the second position, the first of the movable electrical contacts on the movable part 110 can connect fixed electrical contacts 1 and 2 on the housing 118, and the second of the movable electrical contacts on the movable part 110 can connect fixed electrical contacts 4 and 5 on the housing 118. That is, in the second position, the moveable electrical contacts on the moveable part 110 can be electrically connected to a second subset of the fixed electrical contacts on the housing 118. The first subset can be separate from the second subset.

In some embodiments, a bottom of the housing 118 can provide a stopping mechanism for the moveable part 110, for example, when the moveable part 110 is on the second side of the third spring 114.

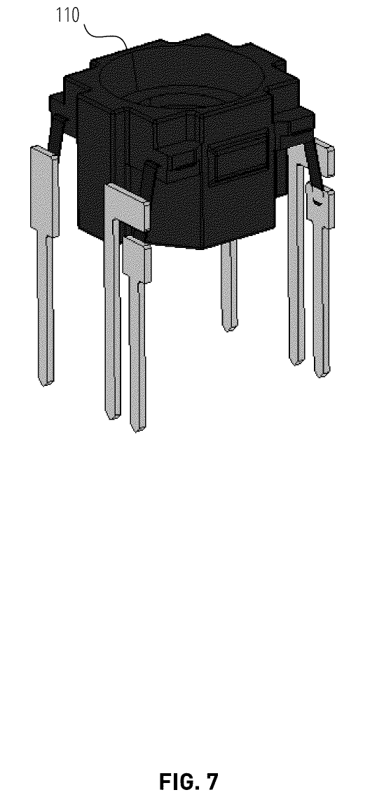

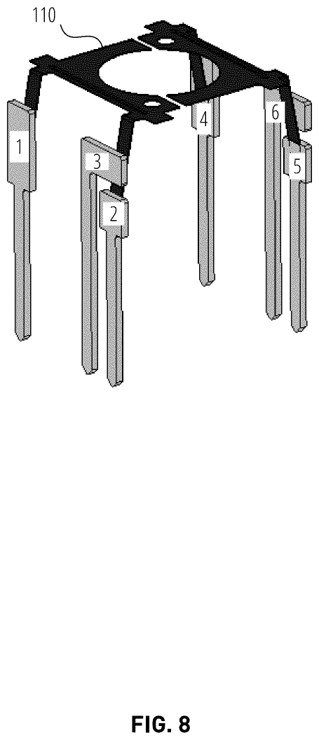

FIG. 7 and FIG. 8 illustrate the movable electrical contacts and the fixed electrical contacts when the snap switch 100 is in the activated position. As seen, the first of the movable electrical contacts on the movable part 110 and the second of the movable electrical contacts on the movable part 110 can be in a second position relative to the fixed electrical contacts when the snap switch 100 is in the activated position, that is, the movable part 110 is in the lower stop position and/or on the second side of the third spring 114.

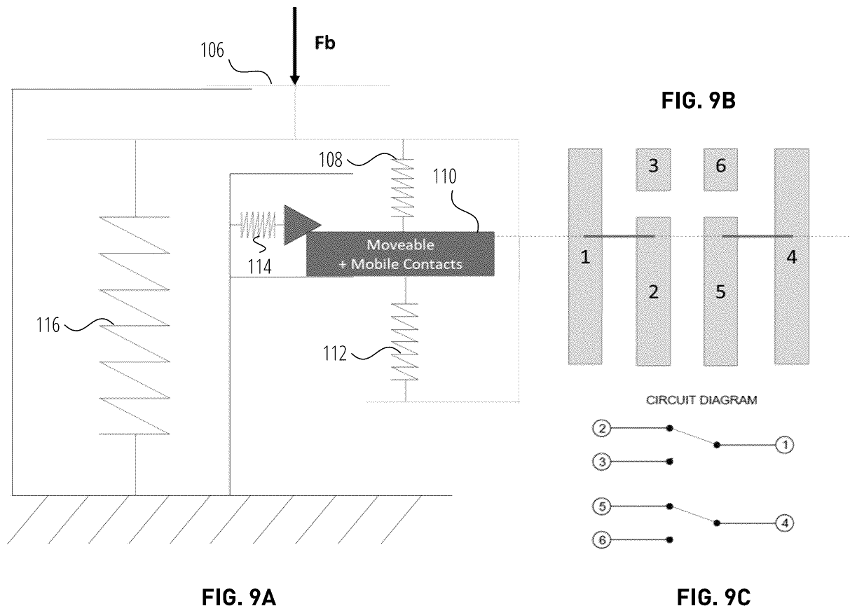

FIG. 9A, FIG. 9B, and FIG. 9C illustrate the snap switch 100 in a mechanical stop position. As seen, a force at mechanical stop Fb can be applied to the actuator 106 and be strong enough to cause the movable part 110 to stay in the lower stop position. In particular, the movable part 110 can be on the second side of the third spring 114 because the second force applied by the second spring 112 on the movable part 110 is lower than the sum of the first force applied by the first spring 108 on the movable part 110 and the reaction force applied by the third spring 114 on the movable part 110. As such, the first of the movable electrical contacts on the movable part 110 can connect fixed electrical contacts 1 and 2 on the housing 118, and the second of the movable electrical contacts on the movable part 110 can connect fixed electrical contacts 4 and 5 on the housing 118. As long as a return condition is not verified, the movable part 110 can remain in the lower stop position regardless of any force applied to the actuator 106 because positioning of the actuator 106 does not change until the return condition is verified.

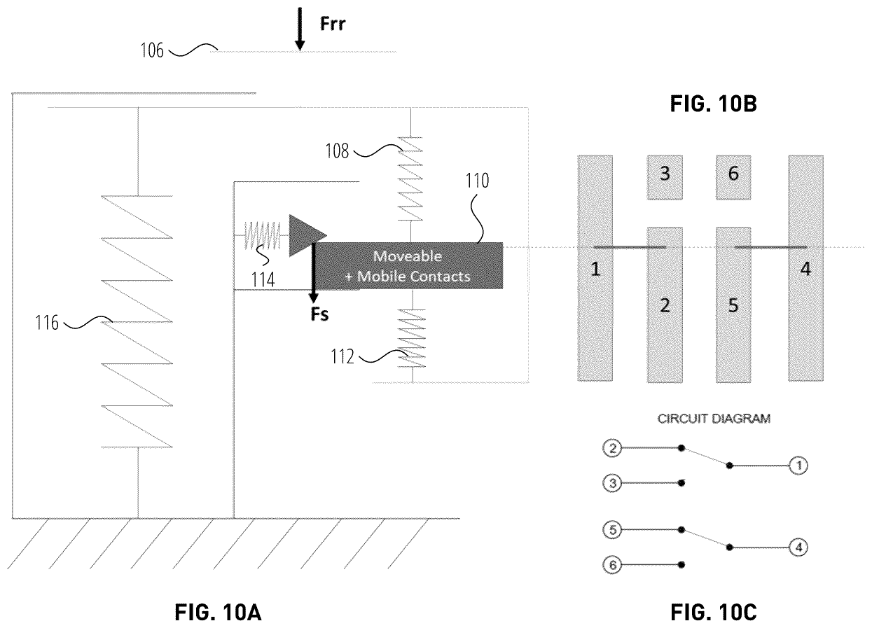

FIG. 10A, FIG. 10B, and FIG. 10C illustrate the snap switch 100 in an unstable position. As seen, a return force Frr can be applied to the actuator 106, but still be strong enough to cause the movable part 110 to stay in the lower stop position. That is, the return condition is still not verified. In particular, the movable part 110 can be on the second side of the third spring 114 because the second force applied by the second spring 112 on the movable part 110 is lower than the sum of the first force applied by the first spring 108 on the movable part 110 and the reaction force applied by the third spring 114 on the movable part 110. As such, the first of the movable electrical contacts on the movable part 110 can connect fixed electrical contacts 1 and 2 on the housing 118, and the second of the movable electrical contacts on the movable part 110 can connect fixed electrical contacts 4 and 5 on the housing 118.

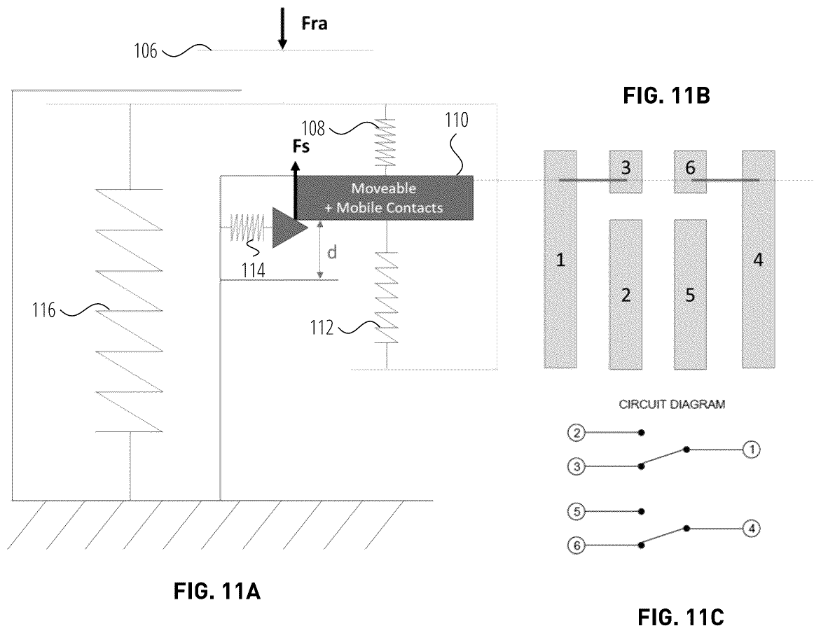

FIG. 11A, FIG. 11B, and FIG. 11C illustrate the snap switch 100 after snap-back, that is, after displacing the third spring 114. As seen, a force after snap-back Fra can be applied to the actuator 106 and be weak enough to cause the reaction force Fs to cause the movable part 110 to move to the upper stop position. That is, the return condition can be achieve when the force after snap-back Fra is applied to the actuator 106. In particular, removal of the outside force applied to the actuator 106 can decrease the first force applied by the first spring 108 on the moveable part 110 and increase the second force applied by the second spring 112 on the moveable part 110 until the equilibrium is reached therebetween and the moveable part 110 pushes past the third spring 114 and moves to the first side of the third spring 114. In some embodiments, potential energy in the second spring 112 can be converted into kinetic energy to move the moveable part 110 from the second side of the third spring 114 to the first side of the third spring 114. As such, the first of the movable electrical contacts on the movable part 110 can connect fixed electrical contacts 1 and 3 on the housing 118, and the second of the movable electrical contacts on the movable part 110 can connect fixed electrical contacts 4 and 6 on the housing 118. After snap-back, the snap switch 100 can return to the free position illustrated in FIG. 2A, FIG. 2B, and FIG. 2C.

As explained above, in some embodiments, the snap switch 100 can include the fourth spring 116. The fourth spring 116 can be located between the actuator 106 and the housing 118, and in these embodiments, the fourth spring 116 can apply the return force Frr to the actuator 106 when the outside force applied to the actuator 106 is removed.

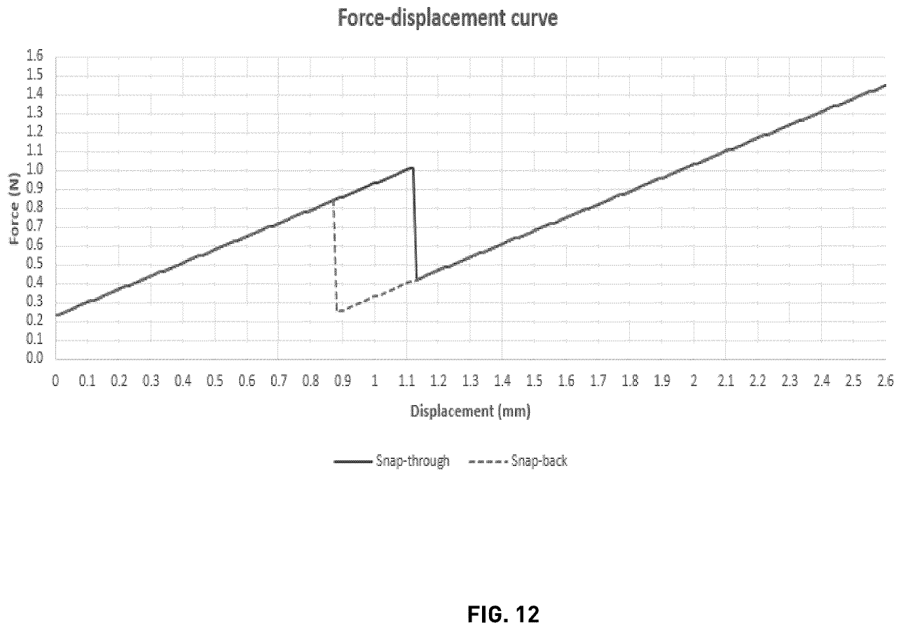

FIG. 12 is a graph illustrating a force-displacement curve in accordance with disclosed embodiments. In particular, a snap-through curve and a snap-back curve illustrate force applied to the actuator 106 as a function of displacement of the actuator 106. Non-linearities on the snap-through curve and the snap-back curve, such as vertical asymptotes, illustrate the impact of quasi-instantaneous displacement of the movable part 110 between the upper stop position and the lower stop position.

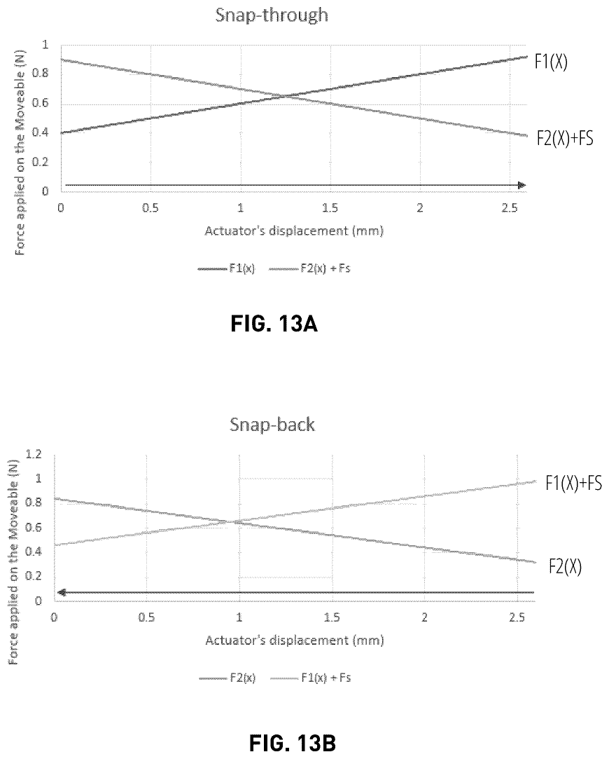

FIG. 13A is a graph illustrating snap-through in accordance with disclosed embodiments, and FIG. 13B is a graph illustrating snap-back in accordance with disclosed embodiments. As seen in FIG. 13A, during switch activation, that is, when the actuator 106 is pushed, the first vertical force F1(x) applied by the first spring 108 on the movable part 110 can increase as the sum of the second vertical force F2(x) applied by the second spring 112 on the moveable part 110 and the reaction force Fs applied by the third spring 114 on the movable part 110 decrease, thereby causing the above-described vertical displacement of the movable part 110. Snap-through occurs when the lines illustrated on the graph in FIG. 13A cross.

Similarly, as seen in FIG. 13B, during switch release, that is, when the actuator 106 is released, the second vertical force F2(x) applied by the second spring 112 on the movable part 110 can decrease as the sum of the first vertical force F1(x) applied by the first spring 108 on the moveable part 110 and the reaction force Fs applied by the third spring 114 on the movable part 110 increase, thereby causing the above-described vertical displacement of the movable part 110, albeit opposite a direction of displacement during the snap-through. Snap-back occurs when the lines illustrated on the graph in FIG. 13B cross.

It is to be understood that the numerical values illustrated on the graphs in FIG. 12, FIG. 13A, and FIG. 13B are exemplary only and that specific values can be achieved by varying parameters of the snap switch 100, including, for example, stiffness or preload of any of the first spring 108, the second spring 112, the third spring 114, and the fourth spring 116, snap amplitude of the third spring 114 and/or the movable part 110, and the like.

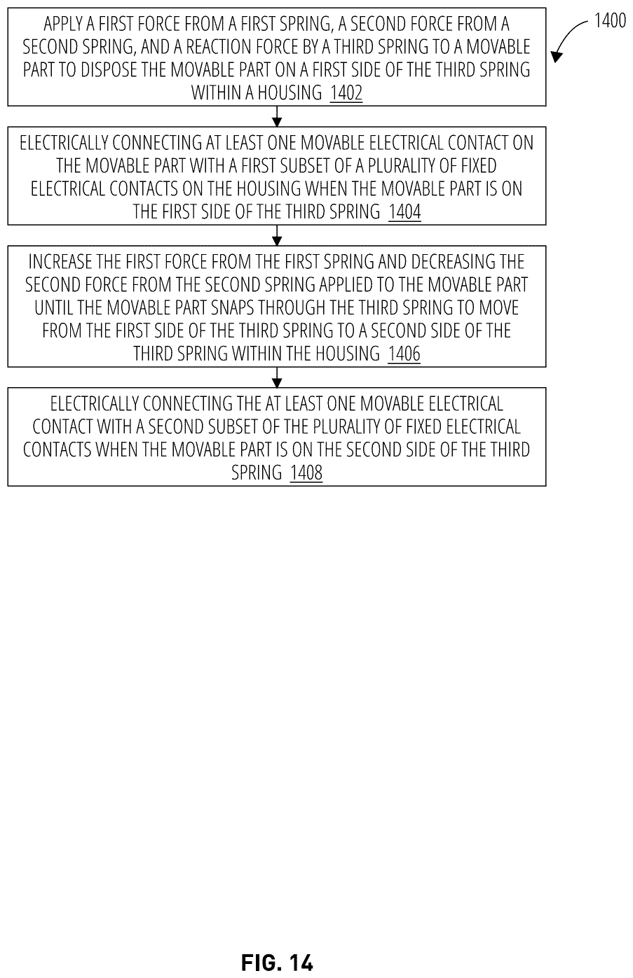

FIG. 14 is a flow chart of a method 1400 in accordance with disclosed embodiments. As seen, the method 1400 can include applying a first force from a first spring, a second force from a second spring, and a reaction force by a third spring to a moveable part to dispose the moveable part on a first side of the third spring within a housing as in 1402. For example, the first force from the first spring can be applied to the moveable part in a first direction, the second force from the second spring can be applied to the moveable part in a second direction, and in some embodiments, the first direction can be opposite the second direction. Further, the reaction force from the third spring can be applied to the moveable part in a third direction, and in some embodiments, the third direction can be different than the first direction and the second direction.

When the moveable part is on the first side of the third spring, the method 1400 can include electrically connecting at least one moveable electrical contact on the moveable part with a first subset of a plurality of fixed electrical contacts on the housing as in 1404.

Then, the method 1400 can include increasing the first force from the first spring and decreasing the second force from the second spring applied to the moveable part until the moveable part snaps through the third spring to move from the first side of the third spring to a second side of the third spring within the housing as in 1406. When the moveable part is on the second side of the third spring, the method 1400 can also include electrically connecting the at least one moveable electrical contact on the moveable part with a second subset of the plurality of fixed electrical contacts on the housing as in 1408.

Although not illustrated in FIG. 14, in some embodiments, the method 1400 can also include decreasing the first force from the first spring and increasing the second force from the second spring applied to the moveable part until the moveable part snaps through the third spring to move from the second side of the third spring to the first side of the third spring.

It is to be understood that increasing and decreasing the first force from the first spring and the second force from the second spring can be done via an actuator located within the housing. In these embodiments, the actuator can be responsive to an outside force. However, embodiments disclosed are not so limited and could include other mechanisms for increasing and decreasing forces from springs as would be understood by one of ordinary skill in the art.

As used herein, an element or a step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations, and changes to the described embodiments are possible without departing from the sphere and scope of the present disclosure, as defined in the appended claims. Accordingly, it is intended that the present disclosure not be limited to the described embodiments, but that it has the full scope defined by the language of the following claims and equivalents thereof.

What is claimed is:

1. A switch comprising:
a housing with a plurality of fixed electrical contacts;
an actuator located within the housing;
a movable part with at least one movable electrical contact and located within the housing;
a first spring located between the actuator and the movable part and applying a first force on the movable part in a first direction;
a second spring located between the actuator and the movable part and applying a second force on the movable part in a second direction, the second direction being opposite the first direction; and
a third spring applying a reaction force on the movable part,
wherein the movable part is on a first side of the third spring when the first force applied by the first spring on the movable part is lower than a sum of the second force applied by the second spring on the movable part and the reaction force applied by the third spring on the movable part,
wherein the at least one movable electrical contact is in a first position relative to the plurality of fixed electrical contacts when the movable part is on the first side of the third spring,
wherein an outside force applied to the actuator increases the first force applied by the first spring on the movable part and decreases the second force applied by the second spring on the movable part until an equilibrium is reached therebetween and the movable part pushes the third spring and moves to a second side of the third spring,
wherein the movable part is on the second side of the third spring when the second force applied by the second spring on the movable part is lower than a sum of the first force applied by the first spring on the movable part and the reaction force applied by the third spring on the movable part,
wherein the at least one movable electrical contact is in a second position relative to the plurality of fixed electrical contacts when the movable part is on the second side of the third spring, and
wherein removal of the outside force applied to the actuator decreases the first force applied by the first spring on the movable part and increases the second force applied by the second spring on the movable part until the equilibrium is reached therebetween and the movable part pushes the third spring and moves to the first side of the third spring.

2. The switch of claim 1 wherein a top cover of the housing provides a stopping mechanism for the movable part and applies a third force on the movable part in the first direction when the movable part is on the first side of the third spring.

3. The switch of claim 1 wherein a bottom of the housing provides a stopping mechanism for the movable part when the movable part is on the second side of the third spring.

4. The switch of claim 1 wherein potential energy in the first spring is converted into kinetic energy to move the movable part from first side of the third spring to the second side of the third spring.

5. The switch of claim 1 wherein potential energy in the second spring is converted into kinetic energy to move the movable part from the second side of the third spring to the first side of the third spring.

6. The switch of claim 1 wherein the first spring and the second spring circumscribe at least part of the actuator.

7. The switch of claim 6 wherein the movable part circumscribes at least part of the first spring and at least part of the second spring.

8. The switch of claim 1 further comprising:
a fourth spring located between the actuator and the housing,
wherein the fourth spring applies a return force to the actuator when the outside force applied to actuator is removed.

9. A switch comprising:
a housing with a plurality of fixed electrical contacts;
an actuator located within the housing;
a movable part with at least one movable electrical contact and located within the housing;
a first spring located between the actuator and the movable part and applying a first force on the movable part in a first direction;
a second spring located between the actuator and the movable part and applying a second force on the movable part in a second direction, the second direction being opposite the first direction; and
a third spring applying a reaction force on the movable part,
wherein the at least one movable electrical contact is in a first position relative to the plurality of fixed electrical contacts when the first force applied by the first spring on the movable part, the second force applied by the second spring on the movable part, and the reaction force applied by the third spring on the movable part cause the movable part to be on a first side of the third spring,
wherein the at least one movable electrical contact is in a second position relative to the plurality of fixed electrical contacts when the first force applied by the first spring on the movable part, the second force applied by the second spring on the movable part, and the reaction force applied by the third spring on the movable part cause the movable part to be on a second side of the third spring, and
wherein the movable part moves between the first side of the third spring and the second side of the third spring.

10. The switch of claim 9 wherein an outside force applied to or removed from the actuator changes the first force applied by the first spring on the movable part and the second force applied by the second spring on the movable part.

11. The switch of claim 9 wherein the reaction force is applied to the movable part in a third direction, and wherein the third direction is different than the first direction and the second direction.

12. The switch of claim 11 wherein the third direction includes a horizontal direction.

13. The switch of claim 9 wherein the third spring undergoes snap-through buckling to facilitate the movable part moving between the first side of the third spring and the second side of the third spring.

14. The switch of claim 9 wherein, in the first position, the at least one movable electrical contact is electrically connected to a first subset of the plurality of fixed electrical contacts, wherein, in the second position, the at least one movable electrical contact is electrically connected to a second subset of the plurality of fixed electrical contacts, and wherein the first subset is separate from the second subset.

15. A method comprising:
applying a first force from a first spring, a second force from a second spring, and a reaction force by a third spring to a movable part to dispose the movable part on a first side of the third spring within a housing;
electrically connecting at least one movable electrical contact on the movable part with a first subset of a plurality of fixed electrical contacts on the housing when the movable part is on the first side of the third spring;
increasing the first force from the first spring and decreasing the second force from the second spring applied to the movable part until the movable part snaps through the third spring to move from the first side of the third spring to a second side of the third spring within the housing; and
electrically connecting the at least one movable electrical contact with a second subset of the plurality of fixed electrical contacts when the movable part is on the second side of the third spring.

16. The method of claim 15 further comprising:
decreasing the first force from the first spring and increasing the second force from the second spring applied to the movable part until the movable part snaps through the third spring to move from the second side of the third spring to the first side of the third spring.

17. The method of claim 16 further comprising:
increasing and decreasing the first force from the first spring and the second force from the second spring via an actuator located within the housing.

18. The method of claim 17 wherein the actuator is responsive to an outside force.

19. The method of claim 15 further comprising:
applying the first force from the first spring to the movable part in a first direction; and
applying the second force from the second spring to the movable part in a second direction,
wherein the first direction is opposite the second direction.

20. The method of claim 19 further comprising:
applying the reaction force from the third spring to the movable part in a third direction,
wherein the third direction is different than the first direction and the second direction.
